(19) United States
(12) Patent Application Publication
(10) Pub. No.: US 2026/0338156 A1
(43) Pub. Date: Oct. 29, 2026

(54) POWER GENERATOR

(71) Applicant: Ciaran PEYTON, Arklow (IE)

(72) Inventor: Ciaran PEYTON, Arklow (IE)

(21) Appl. No.: 19/099,205

(22) PCT Filed: Aug. 1, 2023
(86) PCT No.: PCT/EP2023/071261

§ 371 Date: Jan. 28, 2025

(30) Foreign Application Priority Data
Aug. 3, 2022 (IE) 2022/0128

(51) Int. Cl. F03D 5/06; F03B 17/06

(52) U.S. Cl. CPC F03D 5/06; F03B 17/06; F05B 2210/16; F05B 2250/71

(57) ABSTRACT

The present disclosure is directed an improved system and method for harvesting electrical energy from a fluid flow. In particular, the present disclosure is directed to a system for generating electrical energy from a fluid flow comprising: a foil, wherein: a first end of the foil is connected to a first anchor point by a first tensile connector, and the second end of the foil is connected to a second anchor point by a second tensile connector, and the foil is configured to oscillate in a fluid flow thereby causing the tensile force applied to the anchor points to vary in use, and at least one anchor point is configured to be coupled to a resilient member and a generator, whereby in use oscillations in the position of the at least one anchor point resulting from the varying tensile force are converted into electricity.

### FIELD

The present application is directed towards an improved foil power generator. The term foil as used in this disclosure refers to structure shaped to produce kinetic energy when placed in a moving fluid (e.g. air, water etc.). In this disclosure, a sail is considered to be a type of foil. A hydrofoil refers to a foil configured to work in water and an aerofoil refers to a foil configured to work in air.

### BACKGROUND

At present the use of aerofoils in the field of power generation is known. In particular, flutter aerofoils are available, where the aerofoil is fixed directly to a cantilever. Movement of air around the aerofoil causes lift which results in the aerofoil moving in a first direction. However, the cantilever is biased against movement13 the more the aerofoil is moved in the first direction, the stronger the bias force becomes.

At a certain point, the bias force on the cantilever will overcome the lift on the aerofoil. At this point the movement of the aerofoil will be reversed and the aerofoil will be moved a second direction (opposite the first direction) by the cantilever. As the aerofoil moves in the second direction, the bias force diminishes. Therefore, at a certain point, the lift on the aerofoil will overcome the bias force and the aerofoil will again move in the first direction.

As a result, the position of the aerofoil will oscillate. This oscillation can be used to generate electricity either by using a piezoelectric material on a flexible cantilever or through mounting one element of a magnet and coil pair on a moving part and mounting the other part on a stationary part proximate to the moving part—in this case, oscillating movement of the coil relative to the magnet will generate an oscillating current.

For systems of the kind described above, the aerofoil (and the cantilever) must be moved or rotated relative to the direction of air flow such that the movement of the air applies a force to the aerofoil. I.e. the cantilever and the aerofoil must be angled such that the aerofoil functions as a wing. While the aerofoil and cantilever are being moved into this position, the system will either not work or perform sub-optimally. Another know technology is the use of an aeroelastic wind belt. This uses a strip of elastic placed across an air flow. If the elastic straps are arranged in the same plane as the direction of air flow, then the straps will oscillate due to vortex effects on the strap. A coil and magnet can then be used to convert movement of the elastic strap into electricity. An array of these elastic bands can be provided. And this array must be moved or rotated transverse to the plane of air flow, such that each strap is inline with air flow. While the array is being move into the correct position, the system will either not be generating electricity or will be performing sub-optimally. Further, there are issues with scaling this system—in particular, scaling the system is problematic as larger elastic strap are required. As the size of the strap is increased, the elastic forces of the strap change and become less conducive to electrical generation.

### OBJECT

There is increasing demand for small generators (i.e. generators which can be fixed proximate to, or on, buildings or located close to the ground or in shallow waters). Existing small generators which generate electricity from a moving fluid can struggle to angle into the changing fluid flow direction caused by turbulence. Thus, these types of generators may not be correctly positioned in the fluid flow long enough to capture useable power from the fluid-as such, small generators have proved to be inefficient.

To extract more energy, it is at present necessary to compensate for this inefficacy by capturing a larger cross-sectional area of the fluid flow. This can be seen in the use of arrays of wind turbines with ever increasing blade sizes (and increasing numbers of turbines n the array). However large turbines are not possible for domestic applications, and further large turbines of this sort can only be located in a location with minimal turbulence—e.g. off shore wind-turbines, and water turbines which require large rivers to be dammed, which are expensive to build and have significant environmental impact.

In addition, each of the present methods of harvesting energy from fluid flow operate optimally in a narrow band of fluid speeds.

A new system is needed that can capture fluid flow energy (e.g. from wind or water currents) without the drawbacks of large turbines.

### SUMMARY

The present disclosure is directed an improved system for harvesting electrical energy from a fluid flow. In particular, the present disclosure is directed to a system for generating electrical energy from a fluid flow comprising: a foil, wherein: a first end of the foil is connected to a first anchor point by a first tensile connector, and the second end of the foil is connected to a second anchor point by a second tensile connector, and the foil is configured to oscillate in a fluid flow thereby causing the tensile force applied to the anchor points to vary in use, and at least one anchor point is configured to be coupled to a resilient member and a generator, whereby in use oscillations in the position of the at least one anchor point resulting from the varying tensile force are converted into electricity.

In one embodiment, the foil is an aerofoil. In another embodiment, the foil is a hydrofoil.

Preferably, the system further comprises a lever configured to couple the at least one anchor point to the generator. Optionally, the lever is a cantilever. Preferably, the lever is coupled to the resilient member or the lever comprises the resilient member.

Optionally, the system further comprises a bow; the first anchor point is located on the first limb of the bow; the second anchor point is located on the second limb of the bow; and the bow is configured to be coupled to the resilient member and the generator.

Optionally, the first anchor point is located to a fixed point; and the second anchor point is coupled to the resilient member and the generator.

Optionally, the first and second tensile connectors are first and second portions of a single connector connecting the first limb of the bow to the second limb of the bow.

Preferably, the first and second tensile connectors are formed from one or more threads of a material.

Preferably, the tension of at least one of the first and second connectors is adjustable.

Optionally, the bow comprises a semi-rigid but elastic material which is biased against deformation of the bow. Alternatively, the foil is formed of a rigid material.

The present disclosure is also directed towards a method of generating electricity. The method comprises: providing a foil; coupling a first end of the foil to a first anchor point with a first tensile connector; coupling a second end of the foil to a second anchor point with a second tensile connector; coupling at least one anchor point to a resilient member and a generator; placing the foil in a fluid flow so that the foil oscillates in the fluid flow; and converting oscillations of the position of the at least one anchor point into electricity.

Preferably, coupling at least one anchor point to the resilient member and the generator comprises providing a lever to couple the at least one anchor point to the resilient member and the generator.

Preferably, the lever comprises the resilient member.

### BRIEF DESCRIPTION

The invention will be more clearly understood from the following description of an embodiment thereof, given by way of example only, with reference to the accompanying drawings, in which:

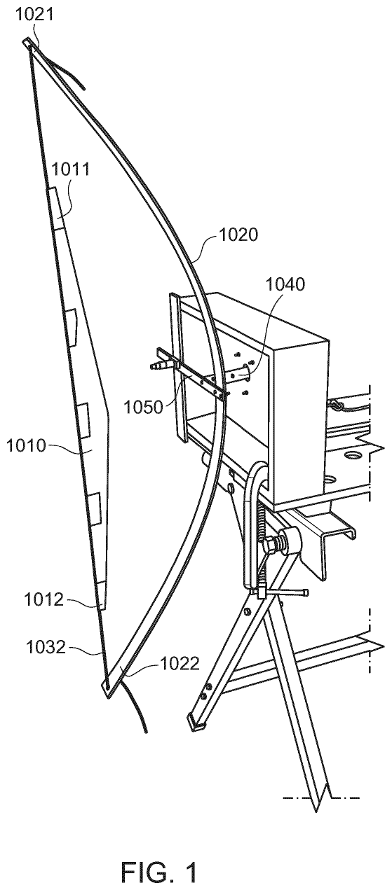

FIG. 1 is a perspective view of a system in accordance with the present disclosure; and

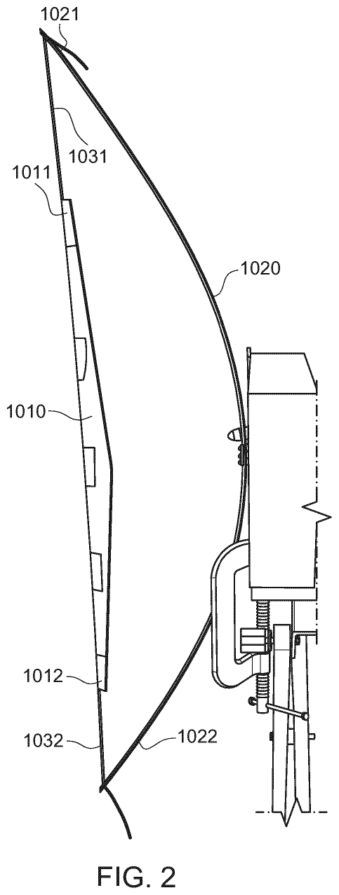

FIG. 2 is a side view of the system.

### DETAILED DESCRIPTION

As shown in FIGS. 1 and 2, the system comprises a foil 1010 and a bow 1020. The term ‘foil’ as used in this disclosure is defined as any structure capable of converting the force from a moving fluid into a motion and includes all suitable sails and foils. The foil 1010 may comprise any suitable fabric or rigid material so long as it holds a shape. For example, the foil 1010 may formed by a fabric held in shape under tension around a rigid frame made of any suitable material. Alternatively, the foil 1010 may be formed from a rigid material. More preferably, the foil 1010 is a foil formed of a lightweight rigid material, for example a composite material such as plastic resin reinforced with a suitable fibre (e.g. fiberglass, carbon fibre, etc).

If the system is configured to harvest energy from air flow, the foil 1010 is preferably an aerofoil. Alternatively, If the system is configured to harvest energy from water flow, the foil 1010 is preferably a hydrofoil.

The foil 1010 has a first end 1011 and an opposing second end 1012. The first end 1011 is preferably connected to a first limb 1021 of the bow 1020 by a first tensile connector 1031. Similarly, the second end 1012 is connected to a second limb 1022 of the bow 1020 by a second tensile connector 1032. Preferably the tensile connectors 1031, 1032 are tensile.

The two limbs 1021, 1022 of the bow 1020 are biased to move away from each other. As a result, the foil 1010 is held in position by the two tensile connectors 1031, 1032 under a tensile force from the bow 1020. Preferably, the two tensile connectors 1031, 1032 are portions of a single connector. For example, one end of the connector can be fixed to a first limb 1021, and the other end of the connector can be fixed to the second limb 1022 such that the connector runs along the long edge of the foil, thereby holding the foil to the bow.

Preferably, the bow comprises a semi-rigid but elastic material which is biased against deformation of the bow. The bow is thus configured such that stringing the bow with the foil 1020 and tensile connectors 1031, 1032 requires the ends of limbs 1021 and 1022 of the bow to be moved into closer proximity to each other. This results in deformation of the semi-rigid but elastic material. As a result, the foil 1010 is held in position under tensile forces applied by the bow 1020 to the foil 1010 via the tensile connectors 1031, 1032.

In use, the foil 1010 is configured to rotate around an axis running between the first 1011 and second 1012 ends of the foil 1010. The foil 1010 is preferably configured such that the area of a first portion of the face of the foil on is greater than the area of a second portion of the face of the foil, where the first and second portions of the foil are divided by the axis running between the first 1011 and second 1012 ends of the foil 1010.

Tensile connectors 1031 and 1032 are formed from one or more threads of any suitable material. For example, tensile connectors 1031 may be formed from one or more of steel, catgut, nylon, linen, plastic, etc. The tensile connectors can be substantively inelastic. Preferably, the tensile connectors 1031, 1032 are flexible. Preferably, the tensile connectors comprise string. The first tensile connector 1031 has a first end attached to the bow and a second end attached to the foil. The second end of the first tensile connector is rotatable around an axis running along the length of the tensile connector. Similarly, the second tensile connector 1032 has a first end attached to the bow and a second end attached to the foil. The second end of the second tensile connector is rotatable around an axis running along the length of the tensile connector. Preferably the second ends of the tensile connectors are rotatable due to the flexibility of the tensile connectors. Thus, the tensile connectors 1031, 1032 allow the foil 1010 to rotate freely.

In use, when the foil 1010 is placed in a flow of fluid, the fluid flow will apply a force in the direction of the fluid flow to the foil 1010. Additionally, the vortexes in the fluid flow around the foil will cause the foil to rotate around the axis running between the first 1011 and second 1012 ends of the foil. As the foil 1010 rotates, a face of the foil 1010 engages with the fluid flow. As the first portion of the face has a greater area that the second portion of the face, the forces applied to the face by the fluid flow will overcome the angular momentum of the foil and reverse the direction of rotation of the foil. Thus, placing the foil 1010 in the fluid flow will cause the foil 1010 to rotatably oscillate around the axis running between the first 1011 and second 1012 ends of the foil 1010.

As foil oscillates, the width of the foil 1010 presented to the fluid flow also oscillates. In particular, the width of the foil 1010 presented to the fluid flow oscillates between a minimum width (when the foil 1010 is parallel to the fluid flow) and a maximum width (when the foil 1010 has rotated to its maximum away from parallel to the fluid flow). Thus, the force applied by the fluid flow to the foil 1010 will oscillate in strength.

The bow 1020 can be mounted on a resilient member and coupled to a generator, for example a linear alternator 1040. Preferably, the resilient member is connected to the centre point along the length of the bow 1020. As a result, the oscillating force applied by the fluid flow can be converted into an oscillating current by the generator.

Preferably, the resilient member is a cantilever 1050. The cantilever is fixed at one end remote from the bow 1020. The linear force applied to the bow 1020 by the fluid flow causes the portion of the cantilever 1050 between the bow 1020 and the fixed end to flex. The magnitude of flex is proportional to the linear force applied to the bow 1020. Thus, the bow will oscillate along an arc defined by the cantilever. The generator is configured to convert this oscillating movement into electrical power.

Alternatively, a hinged leaver fitted with a suitable resilient member (e.g. a spring) can be used instead of a cantilever. In this embodiment, the bow is (or multiple bows are) located at a first end of the lever and a first portion of a generator is on the second end of the lever, wherein the hinge is located between the first and second ends of the lever. The linear force applied to the bow 1020 by the fluid flow causes the first end of the lever will oscillate along an arc defined by the lever. The generator is configured to convert the movement of the lever into electrical power.

Optionally, the tension of the tensile connectors 1031, 1032 is adjustable. For example, the length of one or both of the tensile connectors between the limbs 1021, 1022 of the bow can be adjusted. Alternatively, the biasing force provided by the bow can be adjusted. As rotating the foil will cause forces to be applied to the foil by the fluid, the foil will be displaced causing the tensile connectors 1031, 1032 to flex. Thus, displacement of the foil by the fluid increases the tension of the tensile connectors provides an additional biasing force. As a result, increasing the tension of the tensile connectors 1031, 1032 reduces the magnitude of the rotatory oscillations of the foil and simultaneously increases the frequency of these oscillations.

A fluid flow travelling perpendicular to the length of the foil along a line connecting the foil to the bow provides the most efficient transfer of energy. Nevertheless, locating the foil in a fluid flow of any direction will cause cantilever 1050 to move with substantially the same motion. This makes it particularly suitable to placement on walls.

As will be apparent to those skilled in the art, a system in accordance with the present disclosure does not need bearings or complex gearing to angle into the wind and begin generating electrical power. Further, while the system works best in a steady fluid flow, it adapts easily to efficiently generate electrical power from turbulent fluid flows (e.g. such as wind flows close to ground level or water flows in shallows). The system also works efficiently in a wide range of fluid flows and can harvest electrical energy from windspeeds of over 2 m/s. The system can also be manufactured from a wide range of materials. As a result, a system in accordance with the present disclosure is cheap to produce as well as being robust.

In addition, the system of the present disclosure can be easily scaled because of the use of a foil and one or more connectors. In particular, because the dimensions of the foil and the tension and length of the one or more connectors can all be controlled, it is possible to configure the system to work well with different foil sizes and/or with arrays of foils.

As those of skill in the art will appreciate, and depending on the application at hand, many modifications, substitutions, etc. can be made in and to the present system without departing from the spirit and scope of the present disclosure. The materials, components, and configurations described above may all be altered. Other designs of the frame and energy transfer mechanics are possible. For example, the bow does not necessarily need to be flexible it can be a rigid frame. As a further example, the cantilever 1050 can be replaced, as described above, by a lever and pivot. Alternatively, an array of foils could also use flexible soundboard instead of the cantilever. As yet a further example, gearing can be used to drive a rotary generator instead of using a linear alternator. In addition, the bow may be omitted. For example, one tensile connector may be coupled to a fixed anchor point and the other tensile connector may be coupled to a moveable anchor point that is coupled to a resilient member and the generator. As a result, the position of the moveable anchor point will oscillate as a result of the oscillating force applied by the fluid flow to the foil. This arrangement is particularly suitable for use with a hydrofoil, where the fixed anchor point can be located in a river or sea floor as the moveable anchor point and the generator can be located above water.

In light of this, the scope of the present disclosure should not be limited to that of the particular embodiments illustrated and described in the present disclosure, as they are merely exemplary. Instead, the scope of the present disclosure should be fully commensurate with that of the appended claims and their functional equivalents.

1. A system for generating electrical energy from a fluid flow comprising:
a foil, wherein:
a first end of the foil is connected to a first anchor point by a first tensile connector, and
the second end of the foil is connected to a second anchor point by a second tensile connector, and
the foil is configured to oscillate in a fluid flow thereby causing the tensile force applied to the anchor points to vary in use, and
at least one anchor point is configured to be coupled to a resilient member and a generator, whereby in use oscillations in the position of the at least one anchor point resulting from the varying tensile force are converted into electricity.

2. The system of claim 1, wherein the foil is an aerofoil.

3. The system of claim 1, wherein the foil is a hydrofoil.

4. The system of claim 1, further comprises a lever configured to couple the at least one anchor point to the generator.

5. The system of claim 4, wherein the lever is a cantilever.

6. The system of claim 4 , wherein the lever is coupled to the resilient member or the lever comprises the resilient member.

7. The system of claim 1, further comprising a bow, wherein the first anchor point is located on a first limb of the bow, the second anchor point is located on a second limb of the bow, the bow being configured to be coupled to the resilient member and the generator.

8. The system of claim 1, wherein:
the first anchor point is located to a fixed point; and
the second anchor point is coupled to the resilient member and the generator.

9. The system of claim 1, wherein the first and second tensile connectors are first and second portions of a single connector connecting the first limb of the bow to the second limb of the bow.

10. The system of claim 1, wherein the first and second tensile connectors are formed from one or more threads of a material.

11. The system of claim 1, wherein the tension of at least one of the first and second connectors is adjustable.

12. The system of claim 7, wherein bow comprises a semi-rigid but elastic material which is biased against deformation of the bow.

13. The system of claim 1, wherein the foil is formed of a rigid material.

14. A method of generating electricity comprising:
providing a foil;
coupling a first end of the foil to a first anchor point with a first tensile connector;
coupling a second end of the foil to a second anchor point with a second tensile connector;
coupling at least one anchor point to a resilient member and a generator;
placing the foil in a fluid flow so that the foil oscillates in the fluid flow; and
converting oscillations of the position of the at least one anchor point into electricity.

15. The method of claim 14, wherein coupling at least one anchor point to the resilient member and the generator comprises providing a lever to couple the at least one anchor point to the resilient member and the generator.

16. The method of claim 14, wherein the lever comprises the resilient member.
